(19) United States
(12) Patent Application Publication
(10) Pub. No.: US 2006/0158584 A1
(43) Pub. Date: Jul. 20, 2006

(54) Reflective lcd with saturated colors and high brightness

(75) Inventor: Gerardus Petrus Karman, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics, N.V., Eindhoven (NL)

(21) Appl. No.: 10/560,404

(22) PCT Filed: Jun. 8, 2004
(86) PCT No.: PCT/IB04/50862

§ 371 Date: Dec. 12, 2005

(30) Foreign Application Priority Data
Jun. 16, 2003 (EP) 03101748.6

(51) Int. Cl. G02F 1/1335

(52) U.S. Cl. 349/113

(57) ABSTRACT

The present invention provides a reflective color liquid crystal display (400) comprising a holographic reflector (403) as well as a combination of an absorbing color filter (401) and a diffusive reflector (404). The holographic reflector (403) provides for saturated colors when the display is viewed from a particular direction, and the absorbing filter (401)/diffusive reflector (404) combination provides for acceptable color sutaration when the display is viewed from other directions. Thereby the advantages of a conventional LCD, having a absorbing filter/diffusive reflector combination only, is combined with the advantages of a LCD having a holographic reflector only.

The present invention relates to reflective color Liquid Crystal Displays (LCDs).

In reflective Liquid Crystal Displays, the incoming light is filtered by an absorbing color filter and then reflected in a diff-use manner by an IDR (inner diffusive reflector). The IDR is typically constituted by a metal layer deposited on top of a rough surface so that it acts as a mirror reflecting light not only into the specular direction but also into a range of angles around this direction. Thereby the viewing angle properties of the display are improved.

In order to increase the reflectivity and thus the brightness of conventional reflective color LCDs, their absorbing color filters are designed to have wide RGB (Red, Green, Blue) reflection bands. The edges of the absorption bands of the R, G and B color filters are positioned close together in order to reflect as much light as possible and thus to increase the reflectivity of the LCD. However, wide spectral bandwidths (˜110 nm) also decrease the color purity of the three primary colors R, G and B since high color purity, or saturated colors, require a small spectral bandwidth. Saturated colors are therefore not possible to obtain in conventional reflective color LCDs.

The resulting rather poor color purity is generally taken for granted by users of reflective LCDs (as used in cellular phones, PDAs etc.) because a high brightness is more important. This trade off is however highly unwanted, since color purity is an important aspect with regard to picture quality. Therefore there is a need for improved LCDs that provide for improved color purity without substantially impairing the display brightness.

One way of increasing color purity is to make the absorption bands of the absorbing color filters much more narrow. For example, making the absorption bands only 10 nm wide provides for excellently saturated colors. The obvious drawback of this approach however is that only a small portion of the visible spectrum will be reflected from the display (at most 3×10 nm=30 nm out of the possible 400 nm−700 nm=300 nm range spanning the visible spectrum) thus resulting in a very low overall reflectivity of the display.

A better method of improving the color purity and maintaining a high brightness is to use holographic color filters or holographic reflectors (HR). A HR is a color filter consisting of a stack of dielectric layers acting as an interference filter: it is designed for light with a specific narrow wavelength band which will undergo constructive interference for a specific angle of incidence. Under other angles of incidence and/or other wavelengths, the HR will be virtually transparent. The HR will thus reflect light of a very narrow spectral width (i.e. very saturated light).

The strong wavelength selectiveness of an HR is a general feature of all interference filters and arise from the fact that conditions for constructive interference strongly depend on wavelength. The non-diffuse nature of the reflection ensures that the reflectivity is high: no light is reflected into directions from which the viewer is not looking.

The drawback of this approach is however the strong angular dependence of the reflected light: only for one specific viewing angle the brightness is high; for all other directions the reflectivity is nearly zero and the display is consequently useless for these viewing angles.

The present invention proposes to combine a holographic reflector with a color absorbing filter and an internal diffusive reflector in a reflective LCD. Such a combination provides two immediate benefits: the diffuse reflectivity of all colors remains the same as in a conventional LCD thus providing for normal (limited) color purity; and under one specified viewing angle (depending on the holographic reflector used) the LCD has a much larger color purity and brightness.

Thus, according to one aspect of the invention, a reflective liquid crystal display comprising a liquid crystal layer, an absorbing color filter and a broadband reflector is provided. The inventive LCD further comprises a holographic reflector arranged between said liquid crystal layer and said broadband reflector.

In this way the LCD is provided with an extra feature, namely improved brightness and color purity enhancement for one particular viewing angle, without compromising the existing display performance which customers are used to.

The overall effect for an observer depends on the angle from which the display is observed:

For all angles of incidence, except the one for which the HR is designed (e.g. 30° of normal, a convenient reading orientation), the reflected light will have the broadband spectrum as determined by the absorbing color filter. This is the same as in the conventional color filter design, i.e. a rather poor but generally accepted color purity.

Under 30° of incidence, the reflected light will be a mixture of broadband light and saturated light. The color purity of this mixture is much higher than that of the light in the previous case.

The result is thus that the end user will experience the following: the display behaves as a normal LCD except for a specific angle (for example 30°) where the brightness and color purity will be much better.

There are two ways to achieve this for all colors: either by means of a white HR (effectively a stack of three non-patterned HRs on top of each other, a red, a green, and a blue, all designed for the same angle), or by means of an RGB-patterned HR.

A white HR thus potentially reflects three different colors, but the simultaneous use of a structured absorbing color filter results in only one (broadband) color impinging the HR at any given point and thus ensures that only one (saturated) color is reflected by the HR. For cost reasons, a white HR is the preferred choice for many applications.

The inventive LCD can be employed in any device having a reflective LCD, such as mobile phones, PDAs, portable computers, etc.

As stated above, holographic reflectors are known from other types of LCD applications. HRs can be designed to reflect in the specular angle or in another angle. For this invention it is however important that the HR reflects into essentially one single direction (or, into a range of directions whose spread is very narrow and for practical purposes can be considered as “one” direction). An increased wavelength spread increases the brightness in the reflected angle, but reduces the color purity. For typical applications, an angle spread of less than 10° is acceptable even though the angle spread preferably should be less than 2°. An increased angle spread widens the angle from which the positive effect regarding brightness and color purity is perceived, but of course also reduces the amount of the effect. For most application a wavelength spread of less than 50 nm is acceptable, but a wavelength spread of less than 10 nm is usually preferred.

According to one preferred embodiment, the absorbing color filter is arranged on a viewer side of said holographic reflector. The light impinging the HR is thus already filtered once and the absorbing color filter thereby helps to prevent undesired colors reaching the HR.

In case a white HR is used, the absorbing color filter actually has to be deposited on the viewer side of the HR in order to eliminate any unwanted colors from reaching the HR.

### BRIEF DESCRIPTION OF THE DRAWINGS

In the following, the invention will be further described with reference to the exemplifying drawings, on which:

FIG. 1 schematically shows a conventional reflective LCD.

FIG. 2 shows the absorption spectrum of a conventional absorbing color filter.

FIG. 3 schematically shows a holographic reflector based color filter, in this case for a monochrome display.

FIGS. 4-6 schematically show inventive LCDs, having both an absorbing filter and a holographic reflector.

### EMBODIMENTS OF THE INVENTION

In FIG. 1 a conventional reflective LCD 100 is shown, having an absorbing color filter 101, a liquid crystal layer 102 and an inner diffusive reflector (IDR) 103. In this particular display, the absorbing filter is structured so as to define red (R), green (G) and blue (B) sub-pixels. Light rays impinging the display are thus filtered in the absorbing filter, depending on the local characteristics of the filter. Every light ray except those having red frequencies are thus absorbed in the red portions of the filter and so on. For example, a blue light ray 104 impinging the display at a blue filter portion is thus transmitted through the blue portion as well as through the liquid crystal layer 102 and is reflected diffusively at the diffusive reflector 103, given that the pixel is in an ON-state.

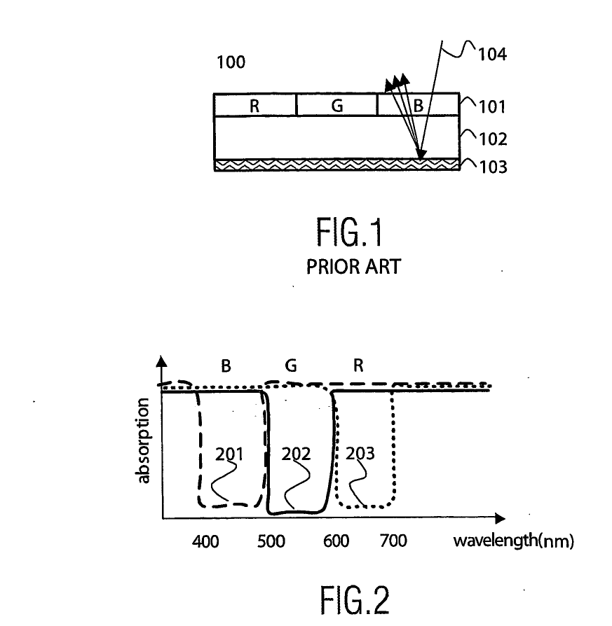

In FIG. 2 are shown the absorption characteristics of a structured absorbing color filter. The dashed line 201 indicates the characteristics of the blue (B) portions, the solid line 202 corresponds to the green portions (G) and the dotted line 203 corresponds to the red (R) portions. As can be seen, the transmissive spectrums of the respective filter portions are almost overlapping; so as to maximize the amount of transmitted light. Thus, in total about one third of the impinging light is transmitted trough the structured absorbing filter.

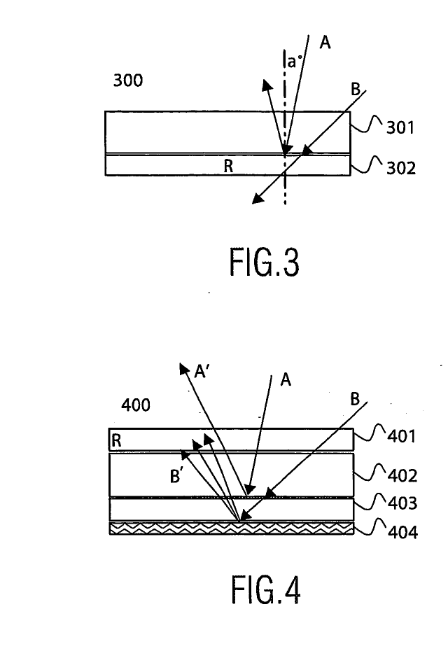

FIG. 3 shows a LCD 300 having a holographic reflector 302, arranged behind a liquid crystal layer 301 and substituting the absorbing color filter as well as the diffusive reflector of FIG. 1. The holographic reflector is designed to reflect light of a certain angle α°. For the sake of clarity, only a red sub-pixel is shown. Thus, a red light ray “A” impinging the display from the angle α° will experience total reflection at the holographic reflector whereas a light ray “B” impinging from a different angle will be unaffected by the holographic filter and will thus be transmitted totally. Total transmission will of course also happen for differently colored light rays, even if they impinge with the required angel α°.

FIG. 4 schematically shows an inventive display 400 having a holographic reflector 403, an absorbing color filter 401 and a diffusive reflector 404. The color filter 401 is arranged on the face side of a liquid crystal layer 402, whereas the holographic reflector 403 and the diffusive reflector 404 are arranged on the backside of the liquid crystal layer 402.

The display properties regarding color purity, viewing angle and brightness can be deduced by considering two red light rays (ray A and B in FIG. 4) impinging a red pixel:

Ray A: This light ray hits the holographic reflector under precisely that angle for which it is designed. This means that the saturated part of the spectrum (pure red in this case) will be specularly reflected into the direction indicated by the arrow A′. This reflection is not diffuse and is therefore of a high amplitude. The remaining parts of the spectrum (as transmitted by the absorbing color filter on top) will behave as ray B.

Ray B: This ray enters under an angle for which the HR is transparent and will therefore be transmitted through the HR and will instead be reflected diffusively by the IDR into the directions indicated by the small arrows B′. The reflectivity is however not as high as for ray A, since it is diffuse.

### Estimate of Improvement

The quantitative improvement obtained by using a holographic reflector can be estimated as follows.

Consider the case of well-defined, collimated ambient illumination and compare the two following situations:

Case 1: Reflection by a conventional IDR only; this IDR has a reflection characteristic that is flat over the angular range −30°-+30°.

Case 2: Reflection by the combination of a HR and an IDR. Assume that the HR reflects a small portion of the visible spectrum (say 3% of the optical spectrum, that is about 10% of all red light) into the angular range −2.5°-+2.5°.

Now consider the light that has passed through the upper absorbing red color filter and denote this amount of light 100%. The issue is what percentage eventually reaches the eye of an observer.

In Case 1 the IDR reflects 100% into the angular range −30°-+30°. The range effectively seen by the user, say −2.50 °-+2.5°, will be reflected only about 0.69% (the solid angle taken spanned by 30° is about (30°/2.5°)ˆ 2=144 times that of 2.5°, and 1/144=0.69%).

In Case 2 the combination of a HR and an IDR will reflect 100% of the small-bandwidth spectrum into the 5° angular range, that is 1/10*100%=10%.

The combination of an HR and an IDR is in the case of perfectly collimated light 10/0.69=14 times more effective than the IDR only. In reality the illumination will however never be perfectly collimated, therefore this estimate will in fact be somewhat lower. But still, the improvement is significant.

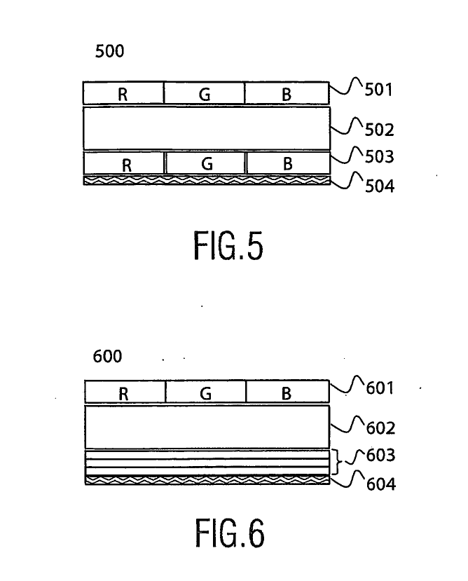

FIG. 5 schematically shows an inventive RGB display 500 having a structured holographic reflector 503, a structured absorbing color filter 501 and a diffusive reflector 504. The color filter 501 is arranged on the face side of a liquid crystal layer 502, whereas the holographic reflector 503 and the diffusive reflector 504 are arranged on the backside of the liquid crystal layer 502.

By structuring the color filter and the holographic reflector a multicolor display is obtained.

FIG. 6 schematically shows a similar structured display 600 having white holographic reflector 603, an absorbing color filter 601 and a diffusive reflector 604. The color filter 601 is arranged on the face side of a liquid crystal layer 602, whereas the holographic reflector 603 and the diffusive reflector 604 are arranged on the backside of the liquid crystal layer 602 again.

In conclusion, the present invention provides a reflective color liquid crystal display (LCD) comprising a holographic reflector as well as a combination of an absorbing color filter and a diffusive reflector. The holographic reflector provides for saturated colors when the display is viewed from a particular direction, and the absorbing filter/diffusive reflector combination provides for acceptable color sutaration when the display is viewed from other directions. Therby the advantages of a conventional LCD, having a absorbing filter/diffusive reflector combination only, is combined with the advantages of a LCD having a holographic reflector only.

1. A reflective liquid crystal display comprising a liquid crystal layer, an absorbing color filter and a broadband reflector, said liquid crystal display further comprising a holographic reflector arranged between said liquid crystal layer and said broadband reflector.

2. A reflective liquid crystal display according to claim 1, wherein said absorbing color filter is arranged on a viewer side of said holographic reflector.

3. A reflective liquid crystal display according to claim 1, wherein said broadband reflector is a diffusive reflector.

4. A reflective liquid crystal display according to claim 1, wherein said absorbing color filter is a structured RGB filter defining red, green and blue sub-pixels, said liquid crystal display thus being a RGB display.

5. A reflective liquid crystal display according to claim 1, wherein said holographic reflector is a white holographic reflector.

6. A reflective liquid crystal display according to claim 4, wherein said holographic reflector is a structured holographic reflector defining red, green and blue sub-pixels corresponding to said absorbing color filter.
